(19) United States
(12) Patent Application Publication
(10) Pub. No.: US 2012/0231767 A1
(43) Pub. Date: Sep. 13, 2012

(54) ANONYMOUS COMMUNICATION METHOD

(75) Inventor: Natsuko Kagawa, Tokyo (JP)

(73) Assignee: NEC CORPORATION, Minato-ku, Tokyo (JP)

(21) Appl. No.: 13/510,195

(22) PCT Filed: Oct. 13, 2010
(86) PCT No.: PCT/JP2010/006068

§ 371 Date: May 16, 2012

(30) Foreign Application Priority Data
Nov. 17, 2009 (JP) 2009-261674

(51) Int. Cl. H04W 12/02

(52) U.S. Cl. 455/411

(57) ABSTRACT

An anonymous communication establishing device establishes a communication session between a first communication terminal and a second communication terminal if the anonymity level of a calling party terminal, designated in a communication connection request received from the first communication terminal, is allowable for a communication from the first communication terminal to the second communication terminal. Then, when the anonymous communication establishing device receives, from the second communication terminal, a communication transfer request designating the first communication terminal as the calling party terminal and designating a third communication terminal as a transfer destination communication terminal, the anonymous communication establishing device determines whether or not the anonymity level of the first communication terminal as the calling party terminal, designated in the communication transfer request, is allowable for a communication from the first communication terminal to the third communication terminal. If the anonymity level is not allowable, the anonymous communication establishing device determines an anonymity level of the first communication terminal allowable for the communication from the first communication terminal to the third communication terminal, and performs transfer control of the communication session with use of the determined anonymity level.

### TECHNICAL FIELD

The present invention relates to an anonymous communication method enabling communication to be performed anonymously, and in particular, to an anonymous communication method having a function of transferring communication sessions.

### BACKGROUND ART

Anonymous communication is communication which is performed without disclosing identity information specifying oneself to the communication counter party. As one example, Non-Patent Document 1 discloses a caller number notification/block service using a voice over IP communication network. In the caller number notification/block service, by setting the caller number to be blocked in the default setting when making a contract, or even without such a setting, by dialing “184” before the telephone number of the connecting phone at the calling party terminal, it is possible to perform communication without notifying the called party terminal of the telephone number of the calling party terminal, that is, to perform anonymous communication. It should be noted that the telephone number of the calling party terminal can be notified to the called party terminal by setting the caller number to be notified in the default setting when making a contact, or even without such a setting, by dialing “186” before the telephone number of the connecting phone at the calling party terminal.

Further, a particular number notification service, described in Non-Patent Document 2, is also a type of anonymous communication. In the particular number notification service, if a caller has signed up for the particular number notification service, an incoming call charge telephone number (a kind of representative number) for which the caller has signed up, rather than the personal telephone number of the calling party terminal, can be notified to the called party terminal.

In the above-described anonymous communication methods, a calling party terminal is able to freely select either to perform communication by disclosing the identification information specifying oneself or to perform communication without disclosing it. In the latter case, as the called party is not able to obtain any information specifying the calling party, it can be said that such communication has the highest anonymity. On the contrary, in the former case, as the calling party can be identified completely, it can be said that such communication has the lowest anonymity. As such, in the above-described anonymous communication methods, a calling party is able to freely select its anonymity level. While there are merits in the case where the calling party is able to freely select its anonymity level, there are also not a few adverse effects such as nuisance phone calls exploiting the anonymity.

As such, regulations on usable anonymity levels can be considered. Specifically, whether or not an anonymity level designated by a communication terminal is allowable is determined based on the anonymity level restriction conditions applied between the communication terminal and the communication counter party, and if it is allowable, a communication session is established between such a terminal and the communication counter party.

Non-Patent Document 1: NIPPON TELEGRAPH AND TELEPHONE WEST CORPORATION, “Voice-over IP Communication. Network Service”, Version 3.0, Feb. 1, 2007, pp. 11, Number Display, [searched on Sep. 7, 2009], Internet <URL:http://www.ntt-west.co.jp/flets/hikaridenwa_office/download/hikari_office3.0.pdf>

Non-Patent Document 2: NIPPON TELEGRAPH AND TELEPHONE WEST CORPORATION, “Particular Number Notification Service”, [searched on Sep. 7, 2009], Internet

<URL:http://www.ntt-west.co.jp/flets/hikaridenwa_office/service/bangoutuuchi/index.html>

Non-Patent Document 3: by Noburou Taniguchi, Koji Chida, Osamu Shionoiri, Atsushi Kanai, IEICE Technical Report SITE 2005-53, “A Note on Anonymity/Pseudonymity/Identity Management of Decentralized Identity Escrow”, the Institute of Electronics, Information and Communication Engineers

Non-Patent Document 4: by Andreas Pfitzmann, Marit Hansen, Anonymity, Unlinkability, Undetectability, Unobservability, Pseudonymity, and Identity Management—A Consolidated Proposal for Terminology, [searched on Sep. 8, 2009], Internet

<URL:http://dud.inf.tu-dresden.de/literatur/Anon_Terminology_v0.31.pdf>

Non-Patent Document 5: Free encyclopedia “Wikipedia”, “anonymity” [searched on Oct. 30, 2009], Internet

<URL:http://ja.wikipedia.org/wiki/%E5%8C %BF%E5%90%8D#.E9.96.A2.E9.80.A3.E9.A0.85.E7.9B.AE>

However, if an anonymity level is regulated by setting anonymity level regulation conditions between communication terminals, when transferring an anonymous communication which was established without being restricted by the regulation to another party, there is a case where the transfer is failed. This is because a combination of the communication parties is changed before and after the transfer so that the anonymity level regulation conditions to be applied are changed accordingly.

In general, transfer of a communication session is performed by establishing another communication session in place of the original communication session. For example, in the case of transferring a communication session, which is established by a user A with a user B at an anonymity level X, by the user B serving as the transfer origin to a user C, a new communication session is established between the user A and the user C who is the transfer destination. As such, if a regulation condition not allowing a communication at the anonymity level X is set to the user C in the relation with the user A, a communication session cannot be established between the user A and the user C, so that the transfer will be failed.

### SUMMARY

An object of the present invention is to provide an anonymous communication method and an anonymous communication establishing device capable of solving a problem that transfer of a communication session may be failed in anonymous communication in which an anonymous level is regulated by setting anonymous level regulation conditions between communication terminals.

An anonymous communication method according to an aspect of the present invention is an anonymous communication method to be performed by an anonymous communication establishing device connected with a plurality of communication terminals over a network. The method includes:

by the anonymous communication establishing device, receiving, from a first communication terminal, a first communication connection request designating a communication address specifying the first communication terminal as a calling party terminal, an anonymity level of the calling party terminal, and a communication address specifying a second communication terminal as a communication counter party;

by the anonymous communication establishing device, determining whether or not the anonymity level of the first communication terminal as the calling party terminal, designated in the received first communication connection request, is allowable for a communication from the first communication terminal to the second communication terminal, and if the anonymity level is not allowable, rejecting the first communication connection request, while if the anonymity level is allowable, establishing a communication session between the first communication terminal and the second communication terminal;

by the anonymous communication establishing device, receiving, from the second communication terminal, a first communication transfer request designating the communication address specifying the first communication terminal as the calling party terminal and a communication address specifying a third communication terminal as a transfer destination communication terminal; and

by the anonymous communication establishing device, determining whether or not the anonymity level of the first communication terminal as the calling party terminal, designated in the received first communication transfer request, is allowable for a communication from the first communication terminal to the third communication terminal, and if the anonymity level is not allowable, determining an anonymity level of the first communication terminal allowable for the communication from the first communication terminal to the third communication terminal, and performing transfer control of the communication session with use of the determined anonymity level of the first communication terminal.

Further, an anonymous communication establishing device, according to another aspect of the present invention, includes:

an anonymity level regulation condition determination means for determining whether or not an anonymity level of a calling party terminal, designated in a communication connection request and a communication transfer request, is allowable;

an anonymity level change means for determining an allowable anonymity level if the anonymity level of the calling party terminal designated in the communication transfer request is not allowable; and

a communication establishing means, wherein

when the communication establishing means receives, from a first communication terminal, a first communication connection request designating a communication address specifying the first communication terminal as the calling party terminal, an anonymity level of the calling party terminal, and a communication address specifying a second communication terminal as a communication counter party, the communication establishing means determines, by using the anonymity level regulation condition determination means, whether or not the anonymity level of the the calling party terminal designated in the first communication connection request is allowable, and if the anonymity level is not allowable, rejects the first communication connection request, while if the anonymity level is allowable, establishes a communication session between the first communication terminal and the second communication terminal, and

when the communication establishing means receives, from the second communication terminal, a first communication transfer request designating the communication address specifying the first communication terminal as the calling party terminal and a communication address specifying a third communication terminal as a transfer destination communication terminal, the communication establishing means determines, by using the anonymity level regulation condition determination means, whether or not the anonymity level of the first communication terminal as the calling party terminal designated in the first communication transfer request is allowable for a communication from the first communication terminal to the third communication terminal, and if the anonymity level is not allowable, determines, by using the anonymity level change means, an anonymity level of the first communication terminal allowable for the communication from the first communication terminal to the third communication terminal, and performs transfer control of the communication session with use of the determined anonymity level of the first communication terminal.

As the present invention is configured as described above, in anonymous communication in which an anonymity level is regulated by setting anonymity level regulation conditions between communication terminals, even if anonymity level regulation conditions to be applied are changed before and after the transfer, such transfer of a communication session will not be failed due to the change in the regulation conditions.

### BRIEF DESCRIPTION OF DRAWINGS

FIG. 1 is a block diagram showing an anonymous communication system according to a first exemplary embodiment of the present invention.

FIG. 2 is a table showing exemplary data stored in an anonymity management information storage section in the first exemplary embodiment of the present invention.

FIG. 3 shows an exemplary format of anonymity level regulation conditions in the first exemplary embodiment of the present invention.

FIG. 4 is an operation illustration of the anonymous communication system according to the first exemplary embodiment of the present invention.

FIG. 5 is a table showing an example of communication party anonymity management information to be used when requesting a communication in the first exemplary embodiment of the present invention.

FIG. 6 is an operation illustration of the anonymous communication system according to the first exemplary embodiment of the present invention.

FIG. 7 is a table showing an example of communication party anonymity management information to be used when transferring a communication in the first exemplary embodiment of the present invention.

### EXEMPLARY EMBODIMENTS

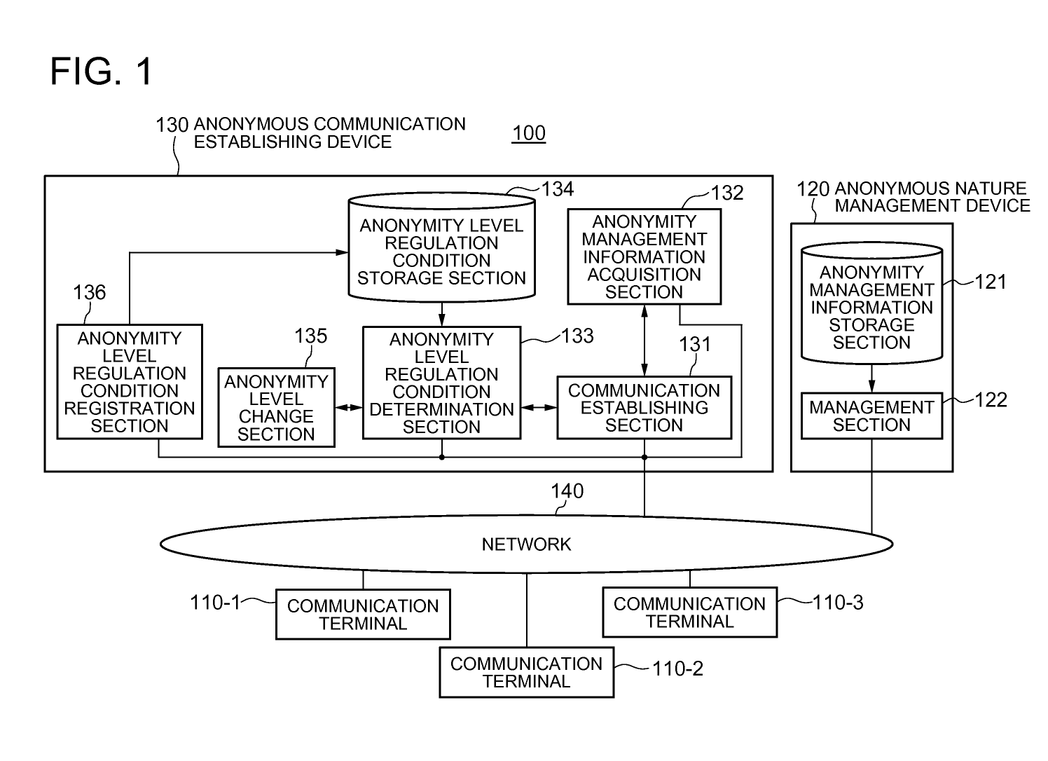

Referring to FIG. 1, an anonymous communication system 100 according to a first exemplary embodiment of the present invention is configured such that a plurality of communication terminals 110, an anonymous nature management device 120, and an anonymous communication establishing device 130 are connected in a communicable manner over a network 140.

Each of the communication terminals 110 is a communication terminal used for anonymous communication, and specifically, is a device having a communication function such as a mobile telephone, a personal computer, or the like. To each of the communication terminals 110, two or more communication addresses including a real address and an anonymous address are assigned.

A real address is an identifier for uniquely identifying the communication terminal 110, which is specifically an individual telephone number, SIP-URI, or the like. As a real address is an identifier which cannot be changed easily for the user, if it is known to a malicious third party, there is a risk of endangering the safety of the user by receiving unnecessary communications, for example.

An anonymous address is an identifier issued in association with a real address. The correspondence relation between the real address and the anonymous address is managed in the anonymous communication system, and is never disclosed to the outside, including the counter party of a communication, when an anonymous communication is performed. As such, the real address of the user will never be known from the anonymous address, enabling an anonymous communication in which the safety of the user is secured. Further, if the anonymous address is known to a malicious third party, it is possible to secure the safety of the real address by invalidating or changing the anonymous address, without changing the real address.

The anonymous nature management device 120 is a device which maintains and manages anonymity management information of the communication terminal 110, and includes an anonymity management information storage section 121 and a management section 122.

The anonymity management information storage section 121 is a database storing anonymity management information of each of the communication terminals 110. The anonymity management information of each communication terminal 110 is constituted of a real address assigned to the communication terminal 110, an anonymous address issued in association with the real address, and information relating to the anonymity level thereof.

An anonymity level is an order of strength of the anonymity. Differences in anonymity levels among anonymous addresses have relativity.

As examples of attributes characterizing the nature of an address, Non-Patent Document 3 defines three concepts including identity, pseudonymity, and anonymity, Non-Patent Document 4 defines six concepts including anonymity, unlinkability, undetectability, unobservability, pseudonymity, and identity, and Non-Patent Document 5 defines two concepts including unlinkability and undeniability. It should be noted that unlinkability means a nature not capable of determining who is the performer, and further, not capable of determining whether or not two actions are performed by the same person, and that undeniability means a nature not capable of proving to a third party that the person who performed an action is not oneself.

In this way, as there are a plurality of hierarchical relations in the natures of an address, it is difficult to define one coherent anonymity level in an arbitrary system. As such, in the exemplary embodiment of the present invention, a manager or a user of an anonymous communication system defines a consistent hierarchical relation of anonymity levels between anonymous addresses within the anonymous communication system.

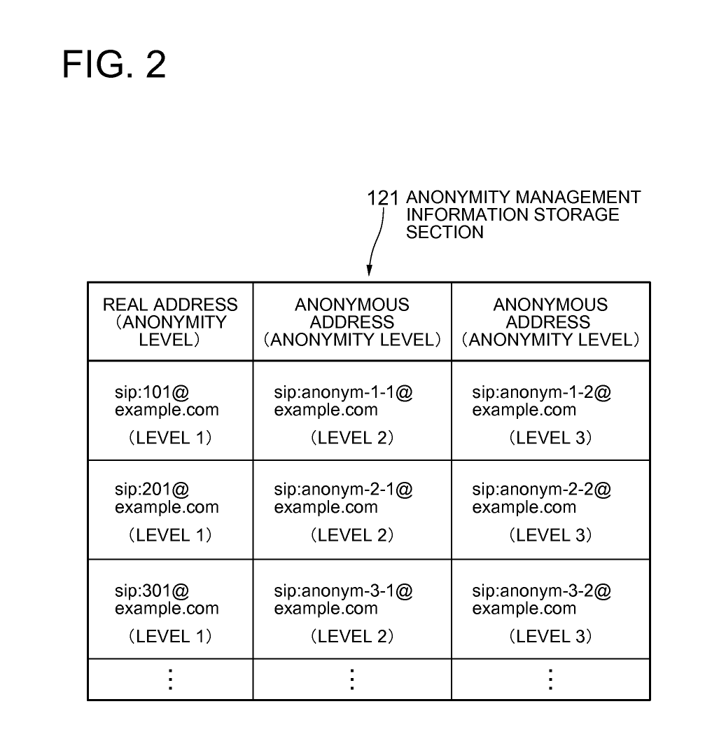

FIG. 2 shows an example of anonymity management information stored in the anonymity management information storage section 121. Referring to FIG. 2, the anonymity management information of the present embodiment is constituted of a real address assigned to the communication terminal 110 and its anonymity level, and two types of anonymous addresses assigned to the communication terminal 110 and their anonymity levels. An anonymity level is represented by a numerical value such that 1 represents the lowest anonymity, and a larger value represents higher anonymity. As the real address has the lowest anonymity because the calling party is completely identifiable, it is set to level 1. The two types of anonymous addresses have a difference in the anonymity. One having lower anonymity, of the two types of anonymous addresses, is set to level 2 which is a second lowest level following the real address, and the other one having higher anonymity is set to level 3.

In the anonymity management information shown in FIG. 2, anonymity levels are added to the real address and the anonymous addresses to thereby clarify the differences in the anonymity level between the addresses. However, it is also possible to omit the anonymity level by storing the addresses in ascending order (or descending order) of the anonymity levels. Further, in addition to the descriptions of the anonymity levels in the anonymity management information, attributes for characterizing the natures of the respective addresses may also be added.

The management section 122 of the anonymous nature management device 120 is a means for, in response to an acquisition request for anonymity management information from the anonymous communication establishing device 130, retrieving the corresponding anonymity management information from the anonymity management information storage section 121 and responding to the anonymous communication establishing device 130.

The anonymous communication establishing device 130 is a device which establishes a communication session between the communication terminals 110, and transfers and abandons the established communication session. When establishing a communication session between the communication terminals 110, the anonymous communication establishing device 130 has a function of determining, in advance, whether or not the anonymity level designated by the calling party terminal is allowable, based on the anonymity level regulation conditions applied between the calling party terminal and the communication counter party terminal, and establishing a communication session only when it is allowable. Further, when transferring a communication session, the anonymous communication establishing device 130 has a function of detecting, in advance, anonymity level regulation conditions applied to the communication parties after the transfer, determining an anonymity level of the communication terminals not regulated by the detected anonymity level regulation conditions, and transferring a communication session using the determined anonymity level. The anonymous communication establishing device 130 of this exemplary embodiment includes a communication establishing section 131, an anonymity management information acquisition section 132, an anonymity level regulation condition determination section 133, an anonymity level regulation condition storage section 134, an anonymity level change section 135, and an anonymity level regulation condition registration section 136.

The communication establishing section 131 has a function of, when receiving a communication connection request designating the called party terminal and the anonymity level transmitted from the communication terminal 110 over the network 140, establishing a communication session between the calling party terminal and the called party terminal, a function of, when receiving a communication transfer request designating the transfer destination terminal transmitted over the network 140 from one of the communication terminals 110 between which a communication session is currently established, transferring the communication session to between the other one of the communication terminals 110, between which the communication session is currently established, and the transfer destination terminal, and a function of abandoning the established communication session when the communication ends.

When establishing a communication session, the communication establishing section 131 acquires anonymity management information of the calling party terminal and anonymity management information of the called party terminal, from the anonymous nature management device 120 via the anonymity management information acquisition section 132, and makes a first determination request to the determination section 133, by adding information of the anonymity level of the calling party terminal designated in the communication connection request to the communication party anonymity management information constituted of the acquired anonymity management information of the calling party terminal and the anonymity management information of the called party terminal. Then, as a response to the first determination request, if receiving a determination result indicating that the anonymity level of the calling party terminal is not subject to regulation from the determination section 133, the communication establishing section 131 establishes a communication session between the calling party terminal and the called party terminal. On the contrary, as a response to the first determination request, if receiving a determination result indicating that the anonymity level of the calling party terminal is subject to regulation from the determination section 133, the communication establishing section 131 does not establish a communication session.

Further, when, from the transfer origin communication terminal of the two communication terminals 110 between which a communication session is currently established, receiving a communication transfer request designating the communication address of the other communication terminal (calling party terminal) and the communication address of the transfer destination terminal transmitted over the network 140, the communication establishing section 131 acquires the anonymity management information of the calling party terminal and the anonymity management information of the transfer destination terminal from the anonymous nature management device 120 via the anonymity management information acquisition section 132, and makes a second determination request to the determination section 133, by adding the communication address of the calling party terminal designated in the communication transfer request to the communication party anonymity management information constituted of the acquired anonymity management information of the calling party terminal and the anonymity management information of the transfer destination terminal. Then, as a replay to the second determination request, when receiving an anonymity level of the calling party terminal to be used at the time of transfer from the determination section 133, the communication establishing section 131 transmits a communication transfer request including the anonymity level and the communication address of the calling party terminal and the communication address of the transfer destination terminal, to the calling party terminal. Then, in response to the communication transfer request, when receiving a communication connection request designating the anonymity level and the communication address of the calling party terminal and the communication address of the transfer destination terminal transmitted from the calling party terminal over the network 140, the communication establishing section 131 performs processing which is the same as that performed when establishing a normal communication section.

The anonymity management information acquisition section 132 is a means for transmitting, to the anonymous nature management device 120, an acquisition request for the anonymity management information of the calling party terminal, the anonymity management information of the called party terminal, and the anonymity management information of the transfer destination terminal over the network 140, in accordance with an instruction from the communication establishing section 131, receiving anonymity management information transmitted from the anonymity nature management device 120 as a response thereof, and transmitting it to the communication establishing section 131.

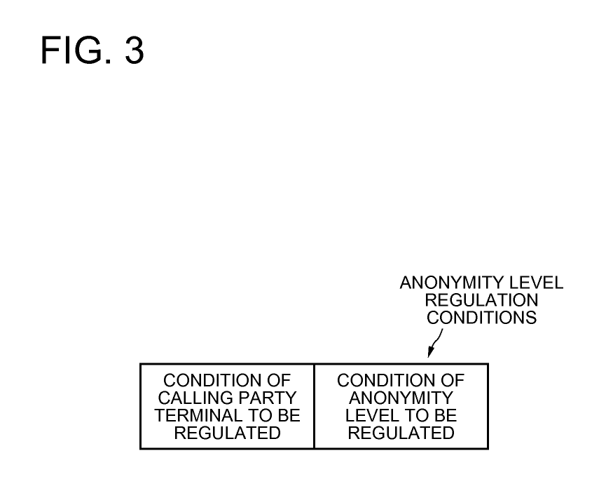

The anonymity level regulation condition storage section 134 is a database storing conditions for regulating the anonymity level of the calling party terminal. As shown in FIG. 3, the anonymity level regulation conditions include a condition of the calling party terminal to be regulated and a condition of the anonymity level to be regulated.

As a condition of the calling party terminal to be regulated, at least one communication address of the communication address specifying the calling party terminal and the communication address specifying the called party terminal is set. For example, if a calling party terminal having a communication address X is to be regulated, the communication address X of the calling party terminal is set as a condition. Meanwhile, if all calling party terminals communicating with a called party terminal having a communication address Y are subject to regulation, the communication address Y of the called party terminal is set as a condition. Further, if a calling party terminal having a communication address X, among the calling party terminals communicating with a called party terminal having a communication address Y, is subject to regulation, the communication address X of the calling party terminal and the communication address Y of the called party terminal are set as a condition. Here, a communication address set as a condition may be a real address or an anonymous address. Further, a communication address set as a condition may be a part of a communication address (domain name, area code, or the like).

As a condition of an anonymity level to be regulated, at least one anonymity level to be regulated is set. For example, if an anonymous address at an anonymity level 3 is not allowed, an anonymity level 3 is set as a condition. If only a real address at an anonymity level 1 is allowed and any anonymous communications at anonymity levels 2 and 3 are not allowed, an anonymity level 2 or higher is set as a condition.

Further, in the conditions of a calling party terminal and an anonymity level to be regulated, it is also possible to set information regarding the time zone to be regulated. For example, if it is desired to regulate communications at an anonymous level of a calling party terminal only in a time zone from 8:00 PM to 8:00 AM next morning, 20:00˜08:00 is set as a regulated time zone in either the condition of the calling party terminal or the condition of the anonymity level.

Further, in the conditions of a calling party terminal and an anonymity level to be regulated, it is also possible to set information regarding the number of communication times to be regulated. For example, if it is desired to regulate communications by a communication terminal at an anonymity level up to three times, the number of communications of more than three times is set as the regulated number of times in either the condition of the communication terminal or the condition of the anonymity level.

Further, in the conditions of the calling party terminal and the anonymous level to be regulated, it is also possible to set information regarding the position of a terminal to be regulated. For example, the case where a distance from a certain reference position is not larger than a predetermined value (or on the contrary, not smaller than a predetermined value) or the case where a distance from the called party terminal is not larger than a predetermined value (or on the contrary, not smaller than a predetermined value) may be subject to regulation.

Further, conditions of the calling party terminal and the anonymity level to be regulated may include a condition of whether or not a call is a callback to a previous call.

The anonymity level regulation condition registration section 136 is a means for registering anonymity level regulation conditions in the anonymity level regulation condition storage section 134. The anonymity level regulation condition registration section 136 receives a registration request from the communication terminal 110 or another terminal such as a personal computer not shown over the network 140, and registers the anonymity level regulation condition attached to the registration request, in the anonymity level regulation condition storage section 134. It should be noted that when registering the anonymity level regulation condition, the anonymity level regulation condition registration section 136 may authenticate the registrant so as to eliminate registration by an illegal registrant.

When the anonymity level regulation condition determination section 133 receives the first determination request from the communication establishing section 131, the anonymity level regulation condition determination section 133 determines whether or not the anonymity level of the calling party terminal received from the communication establishing section 131 is regulated by the anonymity level regulation condition, and notifies the communication establishing section 131 of the result.

On the other hand, if the anonymity level regulation condition determination section 133 receives the second determination request from the communication establishing section 131, the anonymity level regulation condition determination section 133 first determines the anonymity level of the communication address of the calling party terminal received from the communication establishing section 131. Then, the anonymity level regulation condition determination section 133 determines whether or not the determined anonymity level is regulated by the anonymity level regulation condition. If it is not regulated, the anonymity level regulation condition determination section 133 notifies the communication establishing section 131 of the received anonymity level as an appropriate anonymity level of the calling party terminal. On the other hand, if it is regulated, the anonymity level regulation condition determination section 133 notifies the anonymity level change section 135 of the communication party anonymity management information and the anonymity level, and receives a changed anonymity level. Then, the anonymity level regulation condition determination section 133 notifies the communication establishing section 131 of the changed anonymity level as an appropriate anonymity level of the calling party terminal.

The anonymity level change section 135 determines the allowable anonymity level of the calling party terminal in light of the anonymity level regulation condition to be applied in the communication between the calling party terminal and the transfer destination terminal shown in the communication party anonymity management information received from the anonymity level regulation condition determination section 133, and notifies the anonymity level regulation condition determination section 133 of the determined anonymity level.

Next, an exemplary operation of the anonymous communication system 100 according to the present embodiment will be described. As an example, a communication in which the communication terminal 110-1 is the calling party terminal, the communication terminal 110-2 is the transfer origin terminal, and the communication terminal 110-3 is the transfer destination terminal, is described. It is assumed that the user of the communication terminal 110-1 is A, the user of the communication terminal 110-2 is B, and the user of the communication terminal 110-3 is C. Further, it is also assumed that the anonymity management information of the communication terminal 110-1 has the content described in the first row shown in FIG. 2, the anonymity management information of the communication terminal 110-2 has the content described in the second row shown in FIG. 2, and the anonymity management information of the communication terminal 110-3 has the content described in the third row shown in FIG. 2.

First, description will be given on an operation in the case where the communication terminal 110-1 works as a calling party terminal to establish a communication session with the communication terminal 110-2.

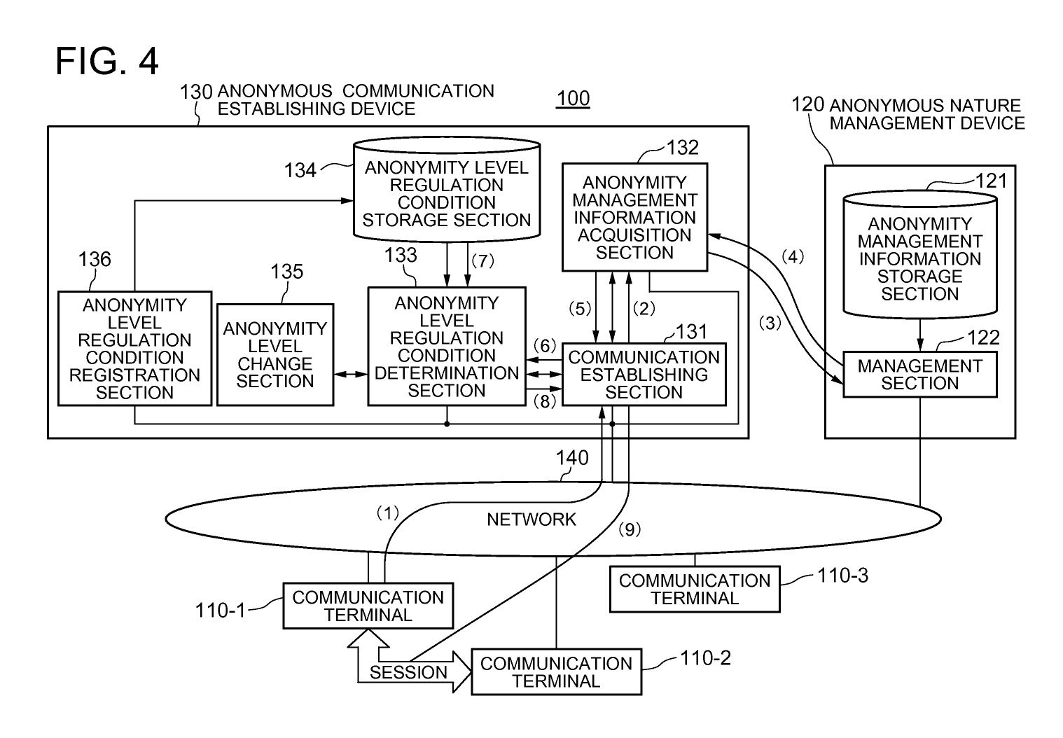

When the user A designates the anonymity level of the calling party terminal on the communication terminal 110-1 to perform calling operation to the user B, a communication connection request is transmitted from the communication terminal 110-1 to the communication establishing section 131 of the anonymous communication establishing device 130 over the network 140 ((1) in FIG. 4). It is assumed that the communication connection request includes, for example, a real address of the communication terminal 110-1 as information specifying the communication terminal 110-1 which is the calling party terminal, and includes, for example, an anonymous address of the communication terminal 110-2 as information specifying the called party terminal. It is also assumed that the anonymity level designated by the calling party terminal is a level X (X represents any value in a range from 1 to 3).

The communication establishing section 131 provides the anonymity management information acquisition section 132 with the real address of the calling party terminal and the anonymous address of the called party terminal included in the communication connection request, and requests to acquire calling party anonymity management information and called party anonymity management information ((2) in FIG. 4).

The anonymity management information acquisition section 132 transmits the acquisition request of the anonymity management information including the real address of the calling party terminal and the acquisition request of the anonymity management information including the anonymous address of the called party terminal, to the management section 122 of the anonymous nature management device 120 over the network 140 ((3) in FIG. 4).

The management section 122 retrieves anonymity management information including a real address which is the same as the real address of the calling party terminal and anonymity management information including an anonymous address which is the same as the anonymous address of the called party terminal, from the anonymity management information storage section 121, and transmits the retrieved pieces of anonymity management information to the anonymity management information acquisition section 132 over the network 140 ((4) in FIG. 4). The anonymity management information acquisition section 132 transmits the received pieces of anonymity management information to the communication establishing section 131 ((5) in FIG. 4). As a result, the anonymity management information in the first row shown in FIG. 2 is provided as the calling party anonymity management information and the anonymity management information in the second row shown in FIG. 2 is provided as the called party anonymity management information, to the communication establishing section 131.

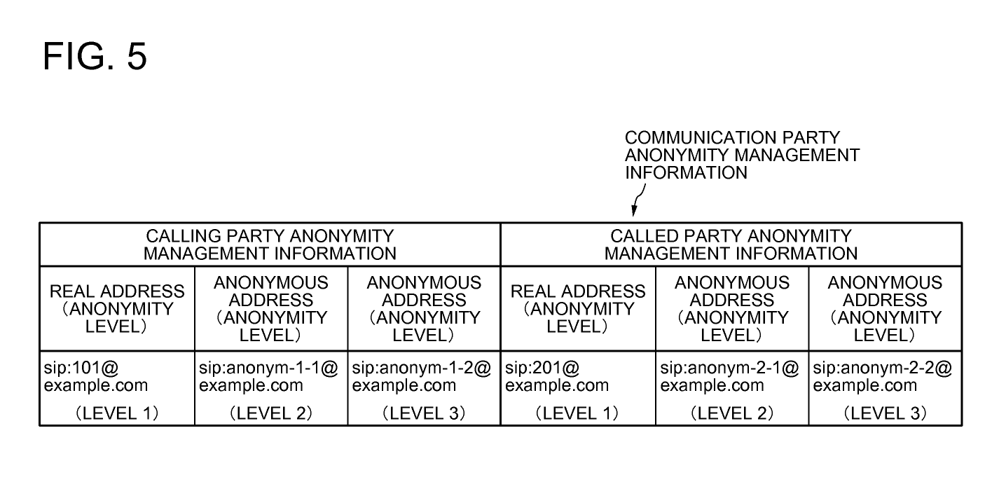

The communication establishing section 131 generates communication party anonymity management information as shown in FIG. 5, including the calling party anonymity management information and the called party anonymity management information, and by attaching the anonymity level X designated by the calling party terminal to the communication party anonymity management information, makes a first determination request to the anonymity level regulation condition determination section 133 ((6) in FIG. 4).

The anonymity level regulation condition determination section 133 determines whether or not the anonymity level X designated by the calling party terminal is allowable in a communication between the calling party terminal and the called party terminal shown in the communication party anonymity management information, based on the anonymity level regulation conditions stored in the anonymity level regulation condition storage section 134 ((7) in FIG. 4). Specifically, for each of the anonymity level regulation conditions stored in the anonymity level regulation condition storage section 134, the anonymity level regulation condition determination section 133 determines whether or not the condition of the calling party terminal is met in the communication of this time. If there is no anonymity level regulation condition in which the condition of the calling party terminal is met, the anonymity level regulation condition determination section 133 notifies the communication establishing section 131 of the determination result that the anonymity level X designated by the calling party terminal is not subject to the regulation ((8) in FIG. 4). On the other hand, if there are one or more anonymity level regulation conditions in which the condition of the calling party terminal is met, the anonymity level regulation condition determination section 133 determines whether or not each of the conditions of the anonymity level is met in the communication of this time. If there is no anonymity level regulation condition in which the condition of the anonymity level is met, the anonymity level regulation condition determination section 133 notifies the communication establishing section 131 of the determination result that the anonymity level X designated by the calling party terminal is not subject to the regulation. On the contrary, if there are one or more anonymity level regulation conditions in which the condition of the anonymity level is met, the anonymity level regulation condition determination section 133 notifies the communication establishing section 131 of the determination result that the anonymity level X designated by the calling party terminal is subject to the regulation ((8) in FIG. 4).

When the communication establishing section 131 receives a determination result that the anonymity level X is subject to the regulation from the anonymity level regulation condition determination section 133, the communication establishing section 131 rejects the communication connection request of this time. Accordingly, a communication session is not established between the communication terminal 110-1 and the communication terminal 110-2, so that the user A and the user B are unable to communicate with each other.

On the other hand, when the communication establishing section 131 receives a determination result that the anonymity level X is not subject to the regulation from the anonymity level regulation condition determination section 133, the communication establishing section 131 establishes a communication session between the calling party terminal 110-1 and the called party terminal 110-2 based on the anonymity level X ((9) in FIG. 4). Specifically, the communication establishing section 131 reads the real address of the communication terminal 110-2 which is the called party terminal from the called party anonymity management information, and notifies the communication terminal 110-2, which is the called party terminal, of the communication address at the anonymity level X of the communication terminal 110-1 which is the calling party terminal, to thereby establish a communication session between the communication terminal 110-1 and the communication terminal 110-2 ((10) in FIG. 4). At this time, if the anonymity level X is 2 or 3, as the real address of the communication terminal 110-1 is not notified to the communication terminal 110-2, the user A is able to perform communication without disclosing his/her real address to the communication counter party B.

In this example, it is assumed that the anonymity level X designated by the calling party terminal is not subject to the regulation, so that a communication session is established between the communication terminal 110-1 and the communication terminal 110-2.

Next, description will be given on the case where the user B performs a transfer operation to the user terminal 110-3 of the user C by a request from the user A or the user B as a result of communication performed between the user A of the communication terminal 110-1 and the user B of the communication terminal 110-2. It is assumed that before the transfer, the user B holds on the communication performed with the user A, establishes a connection with the communication terminal 110-3 of the user C, and notifies the user C of transfer of the communication from the user A. As an establishment of a communication session between the communication terminal 110-2 and the communication terminal 110-3 at this time is performed according to the same procedure as the procedure of establishing a communication session between the communication terminal 110-1 and the communication terminal 110-2, the description thereof is not repeated.

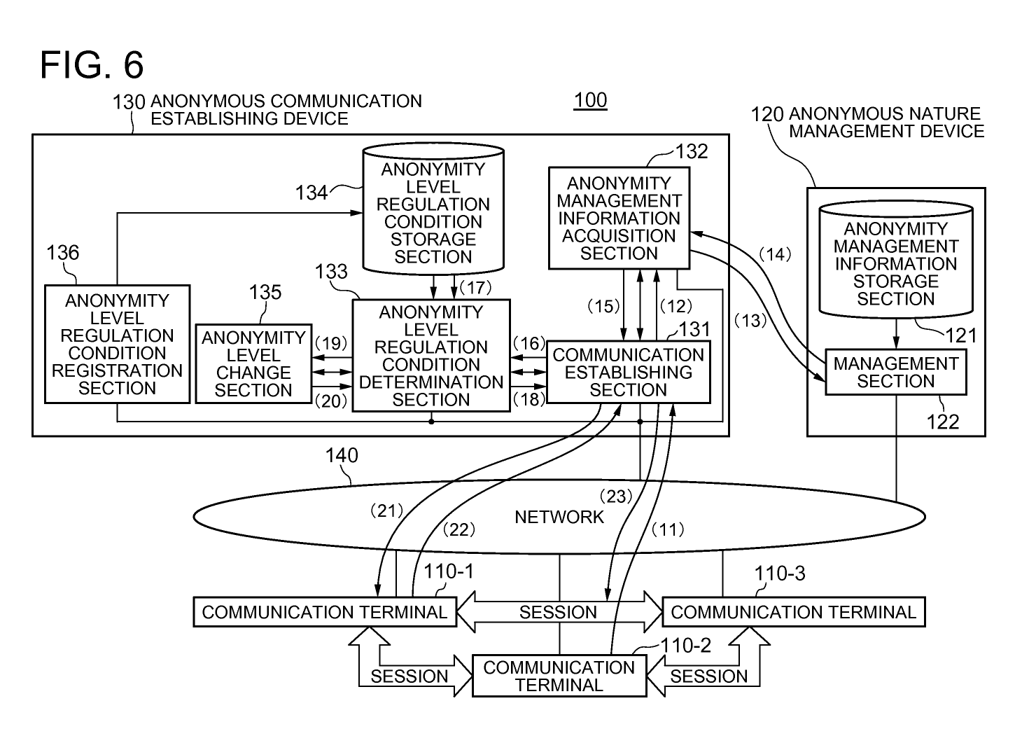

When the user B performs a transfer operation to the user terminal 110-3 on the communication terminal 110-2, a communication transfer request is transmitted from the communication terminal 110-2 to the communication establishing section 131 of the anonymous communication establishing device 130 over the network 140 ((11) in FIG. 6). It is assumed that the communication transfer request includes the anonymous address of the communication terminal 110-1 (the anonymous address at the anonymity level X notified from the communication terminal 110-1 to the communication terminal 110-2 when the communication session is established) as information specifying the calling party terminal, includes a communication address of the communication terminal 110-2, namely a real address for example, as information specifying the transfer origin terminal, and includes a communication address of the communication terminal 110-3, namely an anonymous address for example, as information for specifying the transfer destination terminal.

The communication establishing section 131 provides the anonymity management information acquisition section 132 with the anonymous address of the calling party terminal and the anonymous address of the transfer destination terminal included in the communication transfer request, and request to acquire calling party anonymity management information and transfer destination anonymity management information ((12) in FIG. 6).

The anonymity management information acquisition section 132 transmits an acquisition request of the anonymity management information including the anonymous address of the calling party terminal and an acquisition request of the anonymity management information including the anonymous address of the transfer destination terminal, to the management section 122 of the anonymous nature management device 120 over the network 140 ((13) in FIG. 6).

The management section 122 retrieves anonymity management information including an anonymous address which is the same as the anonymous address of the calling party terminal and anonymity management information including an anonymous address which is the same as the anonymous address of the transfer destination terminal from the anonymity management information storage section 121, and transmits the retrieved pieces of anonymity management information to the anonymity management information acquisition section 132 over the network 140 ((14) in FIG. 6). The anonymity management information acquisition section 132 transmits the received pieces of anonymity management information to the communication establishing section 131 ((15) in FIG. 6). As a result, the anonymity management information in the first row shown in FIG. 2 is provided as the calling party anonymity management information, and the anonymity management information in the third row shown in FIG. 2 is provided as the transfer destination anonymity management information, to the communication establishing section 131.

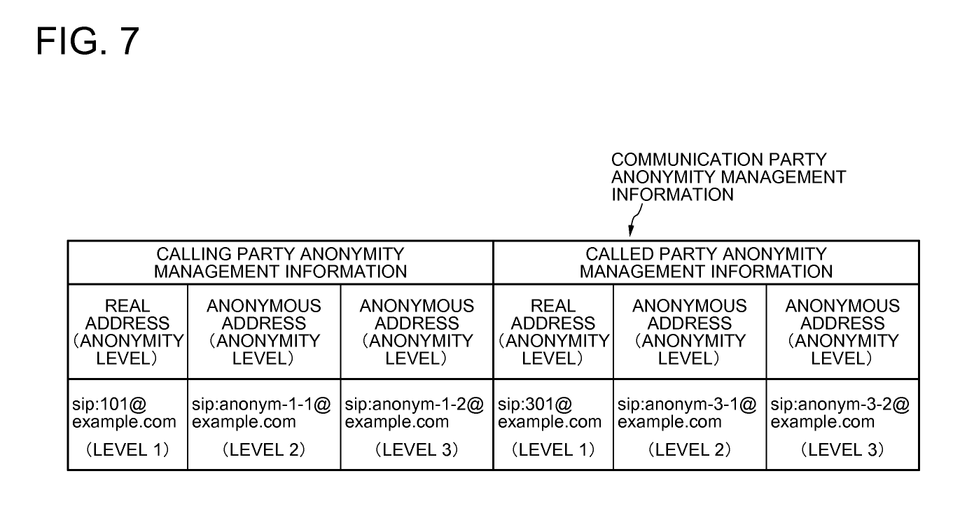

The communication establishing section 131 generates party anonymity management information as shown in FIG. 7, including the calling party anonymity management information and the transfer destination anonymity management information, notifies the anonymity level regulation condition determination section 133 of the party anonymity management information along with the anonymous address of the calling party terminal notified from the transfer origin terminal in the communication transfer request, and requests for an anonymity level to be used by the calling party terminal ((16) in FIG. 6). This means that the communication establishing section 131 makes a second determination request.

The anonymity level regulation condition determination section 133 first extracts the anonymity level X of the notified anonymous address of the calling party terminal. This extraction is carried out by determining which of the anonymous addresses set in the calling party anonymity management information, included in the party anonymity management information, coincides with the notified anonymous address of the calling party terminal.

Then, the anonymity level regulation condition determination section 133 determines whether or not the anonymity level X of the calling party terminal is allowable in the communication between the calling party terminal and the transfer destination terminal shown in the party anonymity management information, based on the anonymity level regulation conditions stored in the anonymity level regulation condition storage section 134 ((17) in FIG. 6). Specifically, for each of the anonymity level regulation conditions stored in the anonymity level regulation condition storage section 134, the anonymity level regulation condition determination section 133 determines whether or not the condition of the calling party terminal is met in the communication of this time. If there is no anonymity level regulation condition in which the condition of the calling party terminal is met, the anonymity level regulation condition determination section 133 determines that the anonymity level X designated by the calling party terminal is not subject to the regulation. On the other hand, if there are one or more anonymity level regulation conditions in which the condition of the calling party terminal is met, the anonymity level regulation condition determination section 133 determines whether each of the the anonymity level conditions is met in the communication of this time. If there is no anonymity level regulation condition in which the condition of the anonymity level is met, the anonymity level regulation condition determination section 133 determines that the anonymity level X designated by the calling party terminal is not subject to the regulation. On the contrary, if there are one or more anonymity level regulation conditions in which the condition of the anonymity level is met, the anonymity level regulation condition determination section 133 determines that the anonymity level X designated by the calling party terminal is subject to the regulation. If the anonymity level X is not subject to the regulation, the anonymity level regulation condition determination section 133 notifies the communication establishing section 131 of the anonymity level X as the anonymity level which should be used by the calling party terminal ((18) in FIG. 6).

On the contrary, if the anonymity level X is subject to the regulation, the anonymity level regulation condition determination section 133 notifies the anonymity level change section 135 of the party anonymity management information shown in FIG. 7 received from the communication establishing section 131 and the applied anonymity level regulation condition ((19) in FIG. 6).

The anonymity level change section 135 first determines an anonymity level Y of the calling party terminal which is allowable in the communication between the calling party terminal and the transfer destination terminal shown in the party anonymity management information, in light of the applied anonymity level regulation condition. At this moment, if there are a plurality of allowable anonymity levels, the anonymity level change section 135 determines any one of the anonymity levels in accordance with the selection criteria which have been set beforehand. The selection criteria include selecting a level having a higher anonymity or, on the contrary, selecting a level having a lower anonymity. Then, the anonymity level change section 135 notifies the anonymity level regulation condition determination section 133 of the determined anonymity level Y as the anonymity level which should be used by the calling party terminal ((20) in FIG. 6).

The anonymity level regulation condition determination section 133 notifies the communication establishing section 131 of the anonymity level Y received from the anonymity level change section 135, as the anonymity level which should be used by the calling party terminal ((18 in FIG. 6).

When the communication establishing section 131 receives the anonymity level Y which should be be used by the calling party terminal from the anonymity level regulation condition determination section 133, the communication establishing section 131 transmits a communication transfer request to the communication terminal 110-1 which is the calling party terminal over the network 140 ((21) in FIG. 6). The communication transfer request includes the anonymity level to be used by the communication terminal 110-1 which is the calling party terminal, and the anonymity address specifying the communication terminal 110-3 which is the transfer destination.

When the communication terminal 110-1 receives the communication transfer request, the communication terminal 110-1 transmits a communication connection request to the communication establishing section 131 of the anonymous communication establishing device 130 over the network 140 ((22) in FIG. 6). The communication connection request includes the real address of the communication terminal 110-1, for example, as information specifying the communication terminal 110-1 which is the calling party terminal, an anonymous address of the communication terminal 110-3 as information specifying the called party terminal, and the anonymity level Y as the anonymity level designated by the calling party terminal.

After this, the procedures which are the same as the procedures described in FIG. 4 will be performed. In those procedures, as it is ensured that the anonymity level Y designated by the communication terminal 110-1, which is the calling party terminal, is not regulated by the anonymity level regulation conditions applied between the communication terminal 110-1 and the communication terminal 110-3 which is the transfer destination, if there is no other impediment, a communication session will be established between the communication terminal 110-1 and the communication terminal 110-3 ((23) in FIG. 6). After this, the communication session between the communication terminal 110-1 and the communication terminal 110-2 and the communication session between the communication terminal 110-2 and the communication terminal 110-3 are abandoned, and only the communication session between the communication terminal 110-1 and the communication terminal 110-3 remains.

As described above, according to the present embodiment, an established communication session can be transferred reliably without running afoul of the anonymity level regulation conditions. On the other hand, if the present invention is not applied, as a communication transfer request transmitted from the communication terminal 110-2 which is the transfer origin is directly relayed to the communication terminal 110-1 which is the calling party terminal via the communication establishing section 131 of the anonymous communication establishing device 130, the communication terminal 110-1 transmits a communication connection request to the communication terminal 110-3, which is the transfer destination, with use of the anonymity level X which is the same as that used for the communication terminal 110-2. As a result, if an anonymity level regulation condition of not allowing a connection at the anonymity level X is set in the communication terminal 110-3, the transfer will be failed. As described above, as the user B holds on the communication with the user A prior to the transfer and connects to the communication terminal 110-3 of the user C to notify the user C of transfer of the communication from the user A, it is desirable to avoid such a transfer failure as much as possible. According to the present invention, in the case of transferring a communication session, established between the communication terminal 110-1 and the communication terminal 110-2, to the communication terminal 110-3 by the communication terminal 110-2 serving as the transfer origin terminal, the anonymity level regulation conditions to be applied between the communication terminal 110-1 which is the calling party terminal and the communication terminal 110-3 which is the transfer destination terminal are detected, an anonymity level of the communication terminal 110-1 not regulated by the detected anonymity level regulation conditions is determined, and with use of the determined anonymity level, a communication session is established between the communication terminal 110-1 and the communication terminal 110-3. Thereby, it is possible to prevent a transfer failure.

### Other Exemplary Embodiments

The present invention is not limited to the above-described exemplary embodiment. Various additions and alterations thereof as described below can be made.

While in the above exemplary embodiment the anonymity level of the calling party terminal is set in the communication connection request, it is possible to designate an anonymous address corresponding to the anonymity level, rather than directly designating the anonymity level. In that case, the anonymous communication establishing device recognizes the anonymity level corresponding to the anonymous address with reference to the anonymity management information of the calling party terminal and then performs the same processing as that in the exemplary embodiment described above.

While in the above exemplary embodiment three different communication addresses of three anonymous levels including a real address and two anonymous addresses are assigned to a communication terminal, in the case of an anonymous communication system in which at least two anonymous levels are assigned to a communication terminal and communication can be made in either of the anonymity levels, the number of communication addresses provided to a communication terminal may be one, two, or three or more. For example, the calling number notification/block service using the voice over IP communication network, described in Non-Patent Document 1, is an example of an anonymous communication system in which communication is performed at two anonymity levels with one communication address.

While in the above exemplary embodiment pieces of anonymity management information of all communication terminals are managed in one anonymous nature management device 120, they may be managed in a plurality of anonymous nature management device 120 in a dispersive manner.

While in the above exemplary embodiment one anonymous communication establishing device 130 recognizes the real address of the communication terminal of the calling party and the real address of the communication terminal of the called party and establishes a communication session between those communication terminals, it is also possible to share establishing of a communication session by a plurality of anonymous communication establishing devices in order that the real addresses of the calling party and the called party are not known to one anonymous communication establishing device. Specifically, a first anonymous communication establishing device which receives a communication connection request including the real address of the calling party and the anonymous address of the called party from the communication terminal of the calling party establishes a communication session with the communication terminal specified by the real address of the calling party, and transmits the anonymous address of the communication terminal of the called party and the anonymous address of the calling party included in the anonymous management information of the calling party acquired from the anonymous nature management device, to a second anonymous communication establishing device. The second anonymous communication establishing device acquires anonymity management information including the real address corresponding to the anonymous address of the called party from the anonymous nature management device, and establishes a communication session with the communication terminal specified by the real address of the called party. Finally, the communication session established by the first anonymous communication establishing device and the communication session established by the second anonymous communication establishing device are linked, whereby a communication session to be used for communication performed between the calling party and the called party is generated.

While in the above exemplary embodiment the present invention is applied to on-hold transfer which is performed by putting a call on hold and transferring it to another party, the present invention is applicable to other types of transfer. For example, the present invention is applicable to the case where the communication terminal 110-1 calls the communication terminal 110-2 but the communication terminal 110-2 does not respond so that the anonymous communication establishing device 130 automatically transfers the call to another predefined communication terminal 110-3.

In the above exemplary embodiment, if there is no anonymity level regulation condition applied between the communication terminal 110-1 and the communication terminal 110-3, the anonymous communication establishing device 130 may automatically generate an anonymity level regulation condition applied between those communication terminals in the anonymity level regulation condition registration section 136 and store it in the anonymity level regulation condition storage section 134. In the anonymity level regulation condition to be generated, it is desirable to regulate anonymity levels higher than the anonymity level X designated by the communication terminal 110-1, which is the calling party terminal, when establishing the communication session before the transfer. Thereby, after the transferred communication session ends, the anonymity level of the calling party terminal 110-1 when the user A directly communicates with the user C can be regulated. It should be noted that confirmation of the presence of an anonymity level regulation condition applied between the communication terminal 110-1 and the communication terminal 110-3 and generation and registration of an anonymity level regulation condition may be performed before processing of the second determination request by the anonymity level regulation condition determination section 133, or may be performed after the processing. In the configuration in which it is performed before the processing of the second determination request, the anonymity level Y to be applied when the communication session is transferred is determined based on the generated anonymity level regulation condition. In that case, however, if the anonymity level X is 1, that is, if the communication terminal 110-1 calls the communication terminal 110-2 using the real address, in order not to fail in the transfer of the communication session to the communication terminal 110-3, the anonymity level to be regulated by the generated anonymity level regulation condition is required to be 2 or higher.

In the above exemplary embodiment, the communication terminal 110-1 may be configured such that when receiving a communication transfer request designating the anonymity level Y from the communication establishing section 131 of the anonymous communication establishing device 130, the communication terminal 110-1 presents the anonymity level Y to the user A, and only when it obtains a response allowing the anonymity level from the user A, the communication terminal 110-1 transmits a communication connection request to the communication establishing section 131 of the anonymous communication establishing device 130 over the network 140 as described above ((22) in FIG. 6).

Further, the functions of the anonymous communication establishing device, the anonymous nature management device, and the communication terminals in the above-described exemplary embodiments can be realized by computers and programs as well as hardware.

### INDUSTRIAL APPLICABILITY

The present invention is applicable to an anonymous communication system used between communication terminals such as mobile telephones over the Internet or a next generation network (NGN), and in particular, to an anonymous communication system having a function of transferring communication sessions.

While the present invention has been described with reference to the exemplary embodiments, the present invention is not limited to the above exemplary embodiments. It will be understood by those skilled in the art that various changes in form and details may be made therein within the scope of the present invention.

This application is based upon and claims the benefit of priority from Japanese patent application No. 2009-261674, filed on Nov. 17, 2009, the disclosure of which is incorporated herein in its entirety by reference.

### REFERENCE NUMERALS

110 communication terminal
120 anonymous nature management device
121 anonymity management information storage section
122 management section
130 anonymous communication establishing device
131 communication establishing section
132 anonymity management information acquisition section
133 anonymity level regulation condition determination section
134 anonymity level regulation condition storage section
135 anonymity level change section
136 anonymity level regulation condition registration section
140 network

1. An anonymous communication method to be performed by an anonymous communication establishing device connected with a plurality of communication terminals over a network, the method comprising:
by the anonymous communication establishing device, receiving, from a first communication terminal, a first communication connection request designating a communication address specifying the first communication terminal as a calling party terminal, an anonymity level of the calling party terminal, and a communication address specifying a second communication terminal as a communication counter party;
by the anonymous communication establishing device, determining whether or not the anonymity level of the first communication terminal as the calling party terminal, designated in the received first communication connection request, is allowable for a communication from the first communication terminal to the second communication terminal, and if the anonymity level is not allowable, rejecting the first communication connection request, while if the anonymity level is allowable, establishing a communication session between the first communication terminal and the second communication terminal;
by the anonymous communication establishing device, receiving, from the second communication terminal, a first communication transfer request designating the communication address specifying the first communication terminal as the calling party terminal and a communication address specifying a third communication terminal as a transfer destination communication terminal; and
by the anonymous communication establishing device, determining whether or not the anonymity level of the first communication terminal as the calling party terminal, designated in the received first communication transfer request, is allowable for a communication from the first communication terminal to the third communication terminal, and if the anonymity level is not allowable, determining an anonymity level of the first communication terminal allowable for the communication from the first communication terminal to the third communication terminal, and performing transfer control of the communication session with use of the determined anonymity level of the first communication terminal.

2. The anonymous communication method according to claim 1, wherein the transfer control of the communication session includes:
by the anonymous communication establishing device, transmitting, to the first communication terminal, a second communication transfer request designating the determined anonymity level of the first communication terminal and the communication address specifying the third communication terminal;
by the anonymous communication establishing device, receiving, from the first communication terminal, a second communication connection request designating the communication address specifying the first communication terminal as the calling party terminal, the anonymity level of the calling party terminal, and the communication address specifying the third communication terminal as a communication counter party; and
by the anonymous communication establishing device, determining whether or not the anonymity level of the first communication terminal as the calling party terminal, designated in the received second communication connection request, is allowable for a communication from the first communication terminal to the third communication terminal, and if the anonymity level is not allowable, rejecting the second communication connection request, while if the anonymity level is allowable, establishing a communication session between the first communication terminal and the third communication terminal.

3. The anonymous communication method according to claim 1, wherein
the anonymous communication establishing device determines whether or not the anonymity level of the first communication terminal is allowable for the communication from the first communication terminal to the second communication terminal and whether or not the anonymity level of the first communication terminal is allowable for the communication from the first communication terminal to the third communication terminal, based on anonymity level regulation conditions including a condition of the calling party terminal to be regulated and a condition of the anonymity level to be regulated.

4. The anonymous communication method according to claim 1, wherein
the anonymous communication establishing device determines the anonymity level of the first communication terminal allowable for the communication from the first communication terminal to the third communication terminal, based on anonymity level regulation conditions including a condition of the calling party terminal to be regulated and a condition of the anonymity level to be regulated, and anonymity management information including a real address of the first communication terminal, at least one anonymous address of the first communication terminal, and information regarding an anonymity level of the anonymous address.

5. The anonymous communication method according to claim 3, wherein
the condition of the calling party terminal to be regulated includes at least one communication address of the communication address specifying the calling party terminal and a communication address specifying a called party terminal.

6. The anonymous communication method according to claim 5, wherein
the condition of the calling party terminal to be regulated includes a condition regarding the number of communication times.

7. The anonymous communication method according to claim 5, wherein
the condition of the calling party terminal to be regulated includes a condition regarding a position of the terminal.

8. The anonymous communication method according to claim 5, wherein
the condition of the calling party terminal to be regulated includes a condition that a call is a callback.

9. The anonymous communication method according to claim 5, wherein
the conditions of the calling party terminal and the anonymity level to be regulated include information regarding a time zone to be regulated.

10. The anonymous communication method according to claim 5, wherein
if there is no anonymity level regulation condition regulating the anonymity level of the first communication terminal as the calling party terminal to be used for the communication from the first communication terminal to the third communication terminal, the anonymous communication establishing device generates a new anonymity level regulation condition which regulates an anonymity level higher than the anonymity level of the first communication terminal as the calling party terminal designated in the received second communication connection request.

11. The anonymous communication method according to claim 1, wherein
if the anonymous communication establishing device transmits the determined anonymity level of the first communication terminal to the first communication terminal and receives an allowance response from the first communication terminal, the anonymous communication establishing device performs transfer control of the communication session with use of the determined anonymity level of the first communication terminal.

12. An anonymous communication establishing device comprising:
an anonymity level regulation condition determination unit that determines whether or not an anonymity level of a calling party terminal, designated in a communication connection request and a communication transfer request, is allowable;
an anonymity level change unit that determines an allowable anonymity level if the anonymity level of the calling party terminal designated in the communication transfer request is not allowable; and
a communication establishing unit, wherein
when the communication establishing unit receives, from a first communication terminal, a first communication connection request designating a communication address specifying the first communication terminal as the calling party terminal, an anonymity level of the calling party terminal, and a communication address specifying a second communication terminal as a communication counter party, the communication establishing unit determines, by using the anonymity level regulation condition determination unit, whether or not the anonymity level of the the calling party terminal designated in the first communication connection request is allowable, and if the anonymity level is not allowable, rejects the first communication connection request, while if the anonymity level is allowable, establishes a communication session between the first communication terminal and the second communication terminal, and
when the communication establishing unit receives, from the second communication terminal, a first communication transfer request designating the communication address specifying the first communication terminal as the calling party terminal and a communication address specifying a third communication terminal as a transfer destination communication terminal, the communication establishing unit determines, by using the anonymity level regulation condition determination unit, whether or not the anonymity level of the first communication terminal as the calling party terminal designated in the first communication transfer request is allowable for a communication from the first communication terminal to the third communication terminal, and if the anonymity level is not allowable, determines, by using the anonymity level change unit, an anonymity level of the first communication terminal allowable for the communication from the first communication terminal to the third communication terminal, and performs transfer control of the communication session with use of the determined anonymity level of the first communication terminal.

13. The anonymous communication establishing device according to claim 12, wherein
the communication establishing unit transmits, to the first communication terminal, a second communication transfer request designating the determined anonymity level of the first communication terminal and the communication address specifying the third communication terminal, and
when the communication establishing unit receives, from the first communication terminal, a second communication connection request designating the communication address specifying the first communication terminal as the calling party terminal, the anonymity level of the calling party terminal, and the communication address specifying the third communication terminal as a communication counter party, the communication establishing unit determines, by using the anonymity level regulation condition determination unit, whether or not the anonymity level of the first communication terminal as the calling party terminal designated in the second communication connection request is allowable for a communication from the first communication terminal to the third communication terminal, and if the anonymity level is not allowable, rejects the second communication connection request, while if the anonymity level is allowable, establishes a communication session between the first communication terminal and the third communication terminal.

14. The anonymous communication establishing device according to claim 12, wherein
the anonymous level regulation condition determination unit determines whether or not the anonymity level of the calling party terminal designated in the communication connection request and the communication transfer request is allowable, based on anonymity level regulation conditions including a condition of the calling party terminal to be regulated and a condition of the anonymity level to be regulated.

15. The anonymous communication establishing device according to claim 12, wherein
the anonymity level change unit determines the allowable anonymity level, based on anonymity level regulation conditions including a condition of the calling party terminal to be regulated and a condition of the anonymity level to be regulated, and anonymity management information including a real address of the communication terminal, at least one anonymous address of the communication terminal, and information regarding an anonymity level of the anonymous address.

16. The anonymous communication establishing device according to claim 14, wherein
the condition of the calling party terminal to be regulated includes at least one communication address of the communication address specifying the calling party terminal and a communication address specifying a called party terminal.

17. The anonymous communication establishing device according to claim 16, wherein
the condition of the calling party terminal to be regulated includes a condition regarding the number of communication times.

18. The anonymous communication establishing device according to claim 16, wherein
the condition of the calling party terminal to be regulated includes a condition regarding a position of the terminal.

19. The anonymous communication establishing device according to claim 16, wherein
the condition of the calling party terminal to be regulated includes a condition that a call is a callback.

20. The anonymous communication establishing device according to claim 16, wherein
the conditions of the calling party terminal and the anonymity level to be regulated include information regarding a time zone to be regulated.

21. The anonymous communication establishing device according to claim 16, further comprising an anonymity level regulation condition registration unit that, if there is no anonymity level regulation condition regulating the anonymity level of the first communication terminal as the calling party terminal to be used for the communication from the first communication terminal to the third communication terminal, generates a new anonymity level regulation condition which regulates an anonymity level higher than the anonymity level of the first communication terminal as the calling party terminal designated in the received second communication connection request.

22. The anonymous communication establishing device according to claim 12, wherein
if the communication establishing unit transmits the determined anonymity level of the first communication terminal to the first communication terminal and receives an allowance response from the first communication terminal, the communication establishing unit performs transfer control of the communication session with use of the determined anonymity level of the first communication terminal.

23. A non-transitory computer readable medium storing a program comprising instructions for causing a computer to function as:
an anonymity level regulation condition determination unit that determines whether or not an anonymity level of a calling party terminal, designated in a communication connection request and a communication transfer request, is allowable;
an anonymity level change unit that determines an allowable anonymity level if the anonymity level of the calling party terminal designated in the communication transfer request is not allowable; and
a communication establishing unit that,
when receiving, from a first communication terminal, a first communication connection request designating a communication address specifying the first communication terminal as the calling party terminal, an anonymity level of the calling party terminal, and a communication address specifying a second communication terminal as a communication counter party, determines, by using the anonymity level regulation condition determination unit, whether or not the anonymity level of the calling party terminal designated in the first communication connection request is allowable, and if the anonymity level is not allowable, rejects the first communication connection request, while if the anonymity level is allowable, establishes a communication session between the first communication terminal and the second communication terminal, and
when receiving, from the second communication terminal, a first communication transfer request designating the communication address specifying the first communication terminal as the calling party terminal and a communication address specifying a third communication terminal as a transfer destination communication terminal, determines, by using the anonymity level regulation condition determination unit, whether or not the anonymity level of the first communication terminal as the calling party terminal designated in the first communication transfer request is allowable for a communication from the first communication terminal to the third communication terminal, and if the anonymity level is not allowable, determines, by using the anonymity level change unit, an anonymity level of the first communication terminal allowable for the communication from the first communication terminal to the third communication terminal, and performs transfer control of the communication session with use of the determined anonymity level of the first communication terminal.

24. The non-transitory computer readable medium according to claim 23, wherein
the communication establishing unit transmits, to the first communication terminal, a second communication transfer request designating the determined anonymity level of the first communication terminal and the communication address specifying the third communication terminal, and
when the communication establishing unit receives, from the first communication terminal, a second communication connection request designating the communication address specifying the first communication terminal as the calling party terminal, the anonymity level of the calling party terminal, and the communication address specifying the third communication terminal as a communication counter party, the communication establishing unit determines, by using the anonymity level regulation condition determination unit, whether or not the anonymity level of the first communication terminal as the calling party terminal designated in the second communication connection request is allowable for a communication from the first communication terminal to the third communication terminal, and if the anonymity level is not allowable, rejects the second communication connection request, while if the anonymity level is allowable, establishes a communication session between the first communication terminal and the third communication terminal.
